(19) United States
(12) Patent Application Publication
(10) Pub. No.: US 2022/0076319 A1
(43) Pub. Date: Mar. 10, 2022

(54) METHOD AND DEVICE FOR RECOMMENDING FASHION COORDINATION BASED ON CLOTHES OWNED BY USER

(71) Applicant: K FIRST LAB CO., LTD., Seoul (KR)

(72) Inventor: Kab Jin KWON, Seoul (KR)

(73) Assignee: K FIRST LAB CO., LTD., Seoul (KR)

(21) Appl. No.: 17/528,114

(22) Filed: Nov. 16, 2021

Related U.S. Application Data
(63) Continuation of application No. PCT/KR2020/005318, filed on Apr. 22, 2020.

(30) Foreign Application Priority Data
May 17, 2019 (KR) 10-2019-0057998

(51) Int. Cl. G06Q 30/06; G06Q 30/02; G06F 16/9536

(52) U.S. Cl. CPC G06Q 30/0631; G06Q 30/0627; G06F 16/9536; G06Q 30/0282

(57) ABSTRACT

A method for recommending fashion coordination based on clothes owned by a user is provided. The method according to an embodiment includes obtaining information regarding clothes owned by a user from a user terminal, obtaining social data connected to the user, calculating feature information indicating a preference for clothes or coordination patterns of the user based on the information regarding the clothes owned by the user and the social data connected to the user, specifying the user in a multidimensional space indicating a degree of similarity between users based on the feature information regarding the user, and providing recommended coordination including at least one clothing item to the user based on feature information regarding at least one user adjacent to the user or a user group in the multidimensional space.

### CROSS-REFERENCE TO RELATED APPLICATION

The present application is a continuation of International Patent Application No. PCT/KR2020/005318, filed on Apr. 22, 2020, which is based upon and claims the benefit of priority to Korean Patent Application No. 10-2019-0057998 filed on May 17, 2019. The disclosures of the above-listed applications are hereby incorporated by reference herein in their entirety.

### BACKGROUND

### 1. Technical Field

The present disclosure relates to a method for recommending fashion coordination based on clothes owned by a user and a device therefor.

### 2. Description of Related Art

In general, each individual has various types of outfits such as clothes, shoes, bags, hats, scarves, accessories, etc. However, few people maintain their styles by using all the fashion items they own. In addition, people tend to usually wear only the style of fashion items they prefer. Even if they have sufficient fashion items to wear, they may not fully utilize the fashion items they own because they may not recognize what type of outfits they have in their wardrobes, or whether their fashion items may be out of style.

Therefore, there is an increasing need to suggest a method to actively use clothing items in wardrobes. Also, it is necessary to help people to fully use the clothing items they own by reflecting their tastes or preferences, etc. for fashion. Also, there is provided a method for recommending fashion coordination using fashion items by reflecting recent trends of other users having similar taste for fashion. In addition, there is provided a method for recommending clothing items suitable for a user in connection with on-line shopping malls, etc., or recommending on-line shopping malls to a user who is willing to purchase fashion items.

### SUMMARY

The present disclosure relates to a method for recommending fashion coordination based on clothing items owned by a user (i.e., fashion items the user owns) and a device therefor.

The present disclosure relates to a method for customizing clothing coordination for each individual based on information regarding clothes a user has by analyzing the features of the user (i.e., taste, preference, etc.) and a device therefor.

The present disclosure relates to a method for recommending clothing coordination that fits to the user by analyzing clothing coordination patterns of other users who have the same or similar features (i.e., taste, preference, etc.) and a device therefor.

The present disclosure relates to a method for providing customized fashion coordination by collecting and analyzing clothing information data or social data of users and a device therefor.

The present disclosure relates to, when there is a need to change clothes (i.e., fashion items the user already owns), or fashion coordination is recommended such as clothes suitable for a user by analyzing clothing coordination patterns of other users of similar features, a method of advertising or promoting products of on-line shopping malls, which are suitable for the users, and a device therefor.

The present disclosure is not limited to clothing items or fashion items such as accessories, etc. but applied to all products in daily life, for example, a recipe customized to each individual may be recommended according to ingredients a user has. In other words, the present disclosure relates to a method for recommending items of which a range is expanded to all items, and a device therefor.

The problems to be solved by the present disclosure are not limited to the problems mentioned above, and other problems not mentioned will be clearly understood by those skilled in the art from the following description.

An aspect of the exemplary embodiments relates to a method for recommending fashion coordination based on clothes owned by a user, comprises obtaining information regarding clothes owned by a user from a user terminal, obtaining social data connected to the user, calculating feature information indicating a preference for clothes or coordination patterns of the user based on the information regarding the clothes owned by the user and the social data connected to the user, specifying the user in a multidimensional space indicating a degree of similarity between users based on the feature information regarding the user, and providing recommended coordination including at least one clothing item to the user based on feature information regarding at least one user adjacent to the user or a user group in the multidimensional space.

The specifying of the user may include obtaining coordinate information corresponding to the feature information regarding the user, and mapping the user to the obtained coordinate information in the multidimensional space.

The recommended coordination may include at least one clothing item among the clothes owned by the user or other clothes, wherein other clothes include at least one or more clothing items for sale which have a feature relating to the feature information regarding the user.

The method may further include providing recommended store information to the user, wherein the recommended store includes selecting whether a clothing item having features the same as or similar to the features information regarding the user is sold among the plurality of stores associated with the server.

The providing of the recommended coordination may include obtaining information according to time, place, and occasion (TPO) from the user terminal, and providing a TPO recommended coordination of highly preferred coordination pattern according to the TPO of at least one user adjacent to the user or a user group in the multidimensional space in consideration of the TPO.

The method may further include obtaining evaluation for the recommended coordination from the user terminal.

The obtaining of the evaluation may include receiving a selected clothing item or coordination selected to be worn by the user among clothing items included in the recommended coordination.

The method may further include updating feature information or preferred coordination patterns of the user or the user group by reflecting preference or degree of satisfaction for the recommended coordination, the selected clothing item, or coordination, or social data associated with the user based on a predetermined period.

According to an exemplary embodiment, there is provided a fashion coordination recommending device based on clothes owned by a user, comprising a memory configured to store at least one instruction, and a processor configured to execute the at least one instruction stored in the memory, wherein the processor is configured to, in response to executing the at least one or more instructions, obtain information regarding clothes owned by a user from a user terminal, calculate feature information indicating preference for the clothes of the user based on the information regarding the clothes owned by the user and social data associated with the user, specify the user in a multidimensional space indicating a degree of similarity between users based on the feature information regarding the user, and provide recommended coordination including at least one clothing item to the user based on feature information regarding at least one user adjacent to the user of a user group in the multidimensional space.

The processor may be configured to, in response to specifying the user, obtain coordinate information corresponding to the feature information regarding the user in the multidimensional space and map the user to the obtained coordinate information.

The recommended coordination may include at least one clothing item among the clothes owned by the user or other clothes, wherein the other clothes include at least one clothing item for sale having similar feature information to the user.

The processor may be configured to provide recommended store information to the user, wherein the recommended store is selected by considering whether a clothing item the same as or similar to the feature information regarding the user is sold among a plurality of stores associated with the server.

The processor may be configured to, in response to providing the recommended coordination, and obtaining information according to Time, Place and Occasion (TPO) from the user terminal, provide TPO recommended coordination of high reference according to the TPO of at least on user adjacent to the user or a user group in the multidimensional space by further considering the obtained TPO.

The processor may be configured to obtain evaluation for the recommended coordination from the user terminal.

The processor may be configured to, in response to obtain the evaluation, receive selected clothing item or coordination selected to be worn by the user among the clothes included in the recommended coordination.

The processor may be configured to update feature information or preferred coordination patterns of the user or a user group by reflecting preference of a degree of satisfaction of the user for the recommended coordination, the selected clothing item or coordination, or social data associated with the user.

A non-volatile computer readable recording medium, wherein a fashion coordination recommended program is recorded based on clothes owned by a user for controlling a computer to perform one of methods of claims 1 to 8.

The present disclosure relates to a method for recommending clothing coordination using clothing items owned by a user by analyzing the features (i.e., taste, reference, etc.) of the user based on the clothing items the user already owns.

The present disclosure produces an effect for recommending fashion coordination following recent fashion trends by analyzing not only the information regarding clothing items owned by the user but also the features (i.e., taste, reference, etc.) of a user by mining social data to which recent fashion trends are reflected.

According to the present disclosure, fashion coordination patterns preferred by users of each group may be identified by recognizing the features of each user (i.e., taste, reference, etc.) through collecting and analyzing clothing information regarding other users, and grouping users who have similar or the same features. In addition, since the users in each group have the same or similar features, each individual may be provided with customized fashion coordination by using the fashion coordination preferred by the users in the same or adjacent groups. In this case, a fashion coordination service with high satisfaction may be provided by considering the preferences of users of similar features.

Effects of the present disclosure are not limited to the above, but other effects not mentioned herein will be clearly understood by those skilled in the art from the following description

### BRIEF DESCRIPTION OF THE DRAWINGS

FIG. 1 is a schematic view illustrating a fashion coordination recommending system based on user clothing items owned by a user according to an embodiment.

FIGS. 2 and 3 are schematic flow charts illustrating a fashion coordination recommending method based on clothing items owned by a user according to an embodiment.

FIG. 4 is an exemplary view illustrating a multidimensional space indicating a degree of similarity among users and a process to generate a user group by grouping the users according to the degree of the similarity among the users within the space according to an embodiment, and

FIG. 5 is a schematic view illustrating components of a device 500 configured to recommend fashion coordination based on clothing items owned by a user according to an embodiment.

### DETAILED DESCRIPTION

Advantages and features of the present disclosure and methods of achieving them may become apparent with reference to the embodiments described below in detail in association with the accompanying drawings. However, the present disclosure is not limited to the embodiments disclosed below, but may be implemented in various different forms, and only the embodiments thereof allow the disclosure of the present disclosure to be complete, and those of ordinary skill in the art to which the present disclosure pertains. It is provided to fully understand the scope of the present disclosure to those skilled in the art, and the present disclosure is only defined by the scope of the claims.

The present disclosure is not limited to embodiments disclosed below and may be implemented in various forms and the scope of the invention is not limited to the following embodiments. Furthermore, a singular form may include a plural from as long as it is not specifically mentioned in a sentence. Furthermore, “include/comprise” or “including/comprising” used in the specification represents one or more components, steps, operations, and elements exist or are added. Terms such as ‘first’ and ‘second’ may be used to describe various components, but they may not limit the various components. Those terms are only used for the purpose of differentiating a component from other components. For example, a first component may be referred to as a second component, and a second component may be referred to as a first component and so forth without departing from the spirit and scope of the present disclosure.

Unless otherwise defined, all terms including technical and scientific terms used herein have the same meaning as commonly understood by one of ordinary skill in the art to which the present disclosure belongs in view of present disclosure. It will be further understood that terms, such as those defined in commonly used dictionaries, should be interpreted as having a meaning that is consistent with their meaning in the context of present disclosure and the relevant art, and will not be interpreted in an idealized or overly formal sense unless expressly so defined herein

As used herein, the term “unit” or “module” may refer to a hardware component such as software, FPGA, or ASIC, and “unit” or “module” may perform certain roles. However, “part” or “module” is not limited to software or hardware. A “unit” or “module” may be configured to reside on an addressable storage medium or to reproduce one or more processors. Thus, by way of example, “part” or “module” refers to components such as software components, object-oriented software components, class components and task components, processes, functions, properties, procedures, subroutines, segments of program code, drivers, firmware, microcode, circuitry, data, databases, data structures, tables, arrays and variables. Components and functionality provided within “parts” or “modules” may be combined into a smaller number of components and “parts” or “modules” or further separated as “parts” or “modules” with additional components.

Hereinafter, embodiments of the present disclosure will be described in detail with reference to the accompanying drawings.

FIG. 1 is a schematic view illustrating a fashion coordination recommending system based on user clothing items owned by a user according to an embodiment.

Referring to FIG. 1, a fashion coordination recommending system 10 (a fashion coordination recommending system) based on clothing items owned by a user may include a server 100 and a user terminal 200.

The server 100 may be a computing device for providing a fashion coordination recommending method based on clothing items owned by a user (i.e., the clothes the user already has), and may perform various functions for providing a customized fashion coordination service based on the clothing items owned by the user. For ease of explanation, FIG. 1 illustrates the server 100 configured in singular, but the fashion coordination recommending system 10 according to an embodiment may include one or more of servers. The server 10 may be a cloud server.

The user terminal 200 may be a terminal device of a user (i.e., a client) using the fashion coordination recommending service based on the clothing items owned by the user provided through the server 100. The user terminal 200 may be a computing device such as a smartphone, a tablet PC, a laptop, a desktop, a smart TV, etc.

The user terminal 200 may include an application for providing the fashion coordination recommending service based on the clothing items owned by the user. Therefore, the user may be provided with the fashion coordination recommending service based on the clothing items owned by the user through the application of the user terminal 200.

A detailed process for providing a fashion coordination recommending method based on the clothing items owned by the user by using the server 100 and the user terminal 200 included in the fashion coordination recommending system 10 will be described.

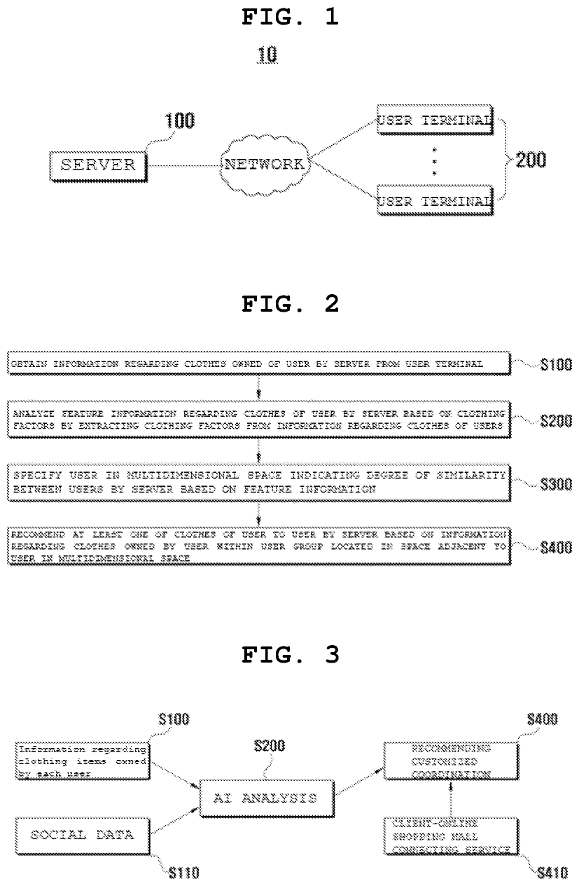

FIGS. 2 and 3 are schematic flow charts illustrating a fashion coordination recommending method based on the clothing items owned by the user according to an embodiment.

FIGS. 2 and 3, the fashion coordination recommending method based the clothing items owned by the user, which is performed by a server according to an embodiment may comprise obtaining information regarding clothing items of a user from a user terminal in operation S100, analyzing features of clothing information regarding the users based on clothing factors by extracting cloth factors from the clothing information regarding the user in operation S200, specifying the users in a multidimensional space indicating a degree of similarity among the users in operation S300, and recommending at least one among clothes of the user based on the information regarding the clothing items owned by the user located in a space adjacent to the user of the multidimensional space in operation S400. The description of each operation will be detailed below.

The server 100 may obtain the information regarding the clothing items owned by the user from the user terminal 200 in operation S100.

The information regarding the clothing items owned by the user may be the clothing items the user already owns, and comprehensively indicates various clothing items and the fashion items the user owns. For example, the information regarding the clothing items owned by the user may include clothing items such as top, bottoms, outer, inner wears, and accessories such as shoes, hats, bags, etc.

For example, the user terminal 200 may directly receive clothing information regarding clothes, shoes, bags, hats, accessories, etc. from the user. For example, the user may directly input the information regarding the clothing items owned by a user such as types, colors, materials, patterns, prices, sizes, etc. of the clothes. The server 100 may receive the clothing information directly received through the user terminal 200.

According to another embodiment, the user terminal 200 may receive the information regarding clothes as images (pictures, video, etc.) from the user. For example, the user may input the pictures or images of clothes, shoes, bags, etc. captured by a camera into the user terminal 200. The server 100 may obtain images including the information regarding the clothing items owned by the user to retain the information regarding the clothes owned by the user by recognizing the information regarding the clothes from the obtained images (for example, types, colors, materials, patterns, sizes, etc. of the clothes). For example, the server 100 may recognize information including types, colors, materials, patterns, sizes, etc. from the images obtained from the user terminal 200 by using an object detection algorithm based on deep-learning (e.g., convolutional neural network (CNN)), and obtain the recognized information as the information regarding the clothing items owned by the user.

According to another embodiment, the user terminal 200 may recognize clothing code information (for example, barcode, QR code, etc.) provided to clothing items, and obtain information regarding the clothing manufacturers or products (types, colors, materials, patterns, prices, size, etc.) from the recognized clothing item code information. The user terminal 200 may recognize the clothing item code information provided to the clothing items and transmit the recognized clothing item code information to the server 100.

The server 100 may establish database for storing and managing clothing item information. The server 100, when obtaining clothing item code information from the user terminal 200, may obtain the information regarding the clothing owned by the user by accessing information regarding the manufacturers or products (types, colors, materials, patterns, prices, sizes, etc.) corresponding to the clothing item code information from the established database. Also, the server 100 may obtain the clothing item information from the clothing manufacturer or retailer in establishing the database.

According to another embodiment, when a user purchases clothes or fashion items from a clothing retailer such as an on-line shopping mall, the user terminal 200 may obtain information regarding the clothes or fashion items purchased by the user from the clothing retailer, and transmit the information to the server 100. For example, the user terminal 200 may obtain the image information related to the clothes and clothing items purchased by the user and transmit the image information to the server 100. The user terminal 200 may obtain identification information related to the clothes or fashion items purchased by the user (e.g., identification information regarding the clothing manufacture or clothing items), and transmit the identification information to the server 100. The server 100 may obtain the information regarding the clothes and fashion items from the clothing manufacturer based on the identification information.

The server 100 may obtain the information regarding the clothes owned by the user through the user terminal 200 in various methods. The information regarding the clothes owned by the user, which is obtained from each user, may be used as big data.

According to an embodiment, the server 100 may establish a big data pipeline by collecting information regarding the clothes of users from each user, analyzing and manufacturing the information for its purpose for use. The server 100 may use artificial intelligence technology, for example, machine learning, deep learning, etc. to analyze and use the information regarding the clothes owned by the users collected from each user. The server 100 may perform training by using information regarding the clothes of users collected by each user and use the information as training data to establish a training model. In using the information regarding the clothes owned by the users as training data, the fashion coordination recommending system 10 according to an embodiment may include an additional server in addition to the server 100.

The server 100 may extract clothing factors from the information regarding clothes of the users obtained in operation S100, and analyze the feature information regarding the clothes owned by the users based on the extracted clothing factors in operation S200.

The clothing factors may indicate information representing the features of the clothes or the fashion items. For example, the clothing factors may include the types, colors, materials, patterns, prices, sizes, brand names, etc.

According to an embodiment, the server 100 may extract at least one clothing factor representing clothing feature from the information regarding the clothes owned by the user. The server 100 may analyze the feature information regarding the clothes owned by the user based on at least one extracted clothing factor, and calculate a feature value of the user.

For example, when extracting the type, color, material of the cloth from a first cloth of the user as a clothing factor, and extracting the type, color, price, brand name of the cloth from a second cloth of the user as a clothing factor, the server 100 may analyze the feature information regarding the clothes owned by the user based on three clothing factors of the first cloth and four clothing factors of the second cloth to calculate the feature value thereof.

The feature information may be information recognized by analyzing entire clothes owned by the user to represent preference information indicating taste information on clothes or coordination patterns, and preferred fashion styles, what type of clothes or clothing item to prefer, etc.

The feature value may be a value indicating the feature information regarding clothes owned by the user, or a multidimensional value in a form of vector of matrix. When the feature value is represented as a multidimensional value based on the clothing factor, the feature values of the multidimensional for each user may be added and arranged in a high-order multidimensional space. The multidimensional space will be described below.

The server 100 may obtain information regarding the clothes owned by the user from each user to analyze the feature information, thereby recognizing the taste and preferred style of each user.

According to an embodiment, the server 100 may use social data in analyzing feature information regarding information regarding the clothes of the users according to an embodiment.

As illustrated in FIG. 3, the server 100 may obtain social data in operation S110.

The social data may various information obtained from social media (e.g., social network service (SNS), blog, twitter, etc.)

For example, the post put up by a user through social medial, the comments on the others' posts, and reactive information (e.g., ‘like’ click information, etc.) may be obtained as social data. The posts put up by acquaintances of the user through the social medial, the comments on the others' posts, and reactive information (e.g., ‘like’ click information) may be obtained as social data. In addition, various information related to the clothes and fashion items posted through the social media may be obtained as social data. In addition, although not directly relevant to the clothes, weather information, etc. that may indirectly affect the clothing may be obtained as the social data.

According to an embodiment, the server 100 may obtain social data related to the user, and analyze the feature information regarding the clothes owned by the user by reflecting the obtained social data connected to the user.

The server 100 may analyze feature information regarding clothes owned by the user by performing data mining on social data obtained in operation S100 along with information regarding the clothes owned by the user, which is obtained in operation S100.

The taste of the user may be analyzed by using the social data connected to the user in addition to the information regarding the clothes owned by the user. In addition, the taste of the user to which the recent trend is reflected by performing data mining on various social data.

The server 100 may specify a degree of similarity of users in a multidimensional space based on feature information regarding the user which is analyzed in operation S200 (in operation S300).

The multidimensional space may indicate the degree of the similarity of the users, and represent a multidimensional coordinate space generated by mapping users having similarity feature information to the same or similar space based on the feature information regarding each user.

According to an embodiment, the server 100 may obtain coordinate information corresponding to the feature information (i.e., feature value) of the users in the multidimensional space, and perform mapping the user to the obtained coordinate information.

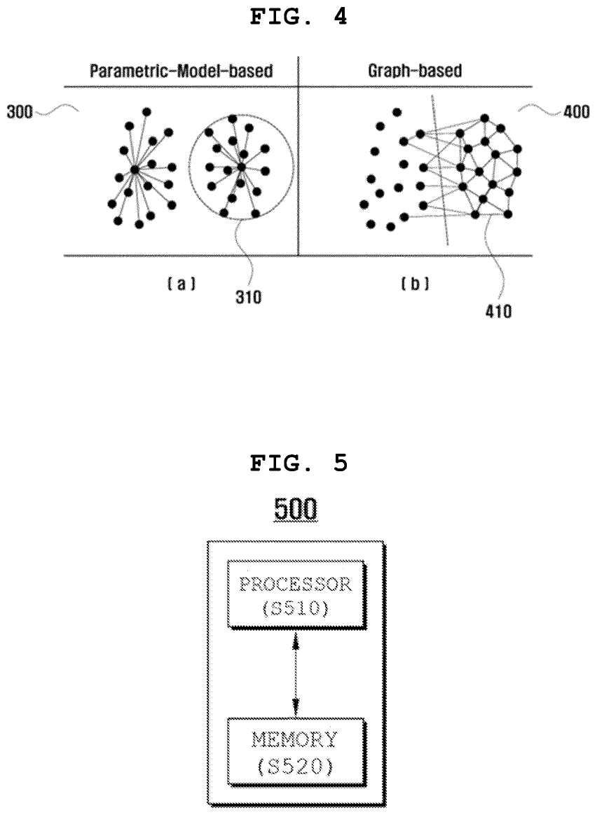

FIG. 4 is an exemplary view illustrating a multidimensional space indicating a degree of similarity among users and a process to generate a user group by grouping the users according to the degree of the similarity among the users within the space according to an embodiment.

Referring to FIG. 4, the server 100 may perform mapping each user to a particular position of multidimensional spaces 300 and 400 by using feature information analyzed based on information regarding the clothes owned by the user. Each point illustrated on the multidimensional spaces 300 and 400 may represent each user mapped to a particular position on the multidimensional spaces 300 and 400.

The server 100 may generate at least one or more of user groups 310 and 410 based on a degree of similarity of users (i.e., feature information such as taste, preferred style, etc.) mapped to particular positions of the multidimensional spaces 300 and 400.

According to an embodiment, the server 100 may analyze feature information regarding at least one user based on information obtained from at least one user terminal 200. The server 100 may calculate the coordinate information on the multidimensional spaces 300 and 400 corresponding to the feature information regarding at least one user, and perform mapping each user to each calculated coordinate information. The server 100 may generate at least one or more of user groups 310 and 410 by grouping users representing similar feature information based on feature information regarding at least one user mapped to the multidimensional spaces 300 and 400.

The users in the same user groups 310 and 410 may be considered to have same or similar feature information (e.g., taste, preferred style, etc.). For example, the users in the same user groups 310 and 410 may obtain similar or same clothes or fashion items.

In generating user groups in a multidimensional space, the server 100 may perform grouping on users having similar features by applying artificial intelligence (i.e., unsupervised learning machine learning, deep learning, etc.) such as a clustering, a collaborative filtering, etc.

In generating user groups in the multidimensional space, the server 100 may perform mapping on users to the multidimensional space 300 in a Parametric Model-based form, or perform mapping on users to the multidimensional space 400 in a Graph-based form.

The present disclosure is not limited to the Parametric Model-based form or Graph-based form, but may be mapped or configured in various forms.

As illustrated in FIG. 4, the server 100 may establish a multidimensional space categorized by grouping users having same or similar information for a number of users. The server 100, when obtaining information regarding clothes owned by a new user, or obtaining new clothing information from a previous user, may perform mapping the user to a particular position on the established multidimensional space by analyzing feature information, and perform grouping the users into a user group consisting of users who have same or similar features in the multidimensional space based on the mapped position.

For example, the server 100, when obtaining new clothing information from the user terminal 200 of the previous user, may renew the feature information regarding the clothing information regarding the user by reflecting new clothing information along with the previous clothing information. The server 100 may calculate coordinate information corresponding to the feature information renewed in the multidimensional space, and change a position of the user to the calculated coordinate information based on the renewed feature information. In response to the change of the position of the user in the multidimensional space, the user may be grouped to another user group, not the previous user group. In this case, it may be inferred that the feature of the user (i.e., preference or taste, etc.) is changed.

The server 100 may obtain information regarding the clothes owned by the users from the user terminal 200 based on a predetermined period (e.g., daily, weekly, monthly, etc.), and reflect the information regarding the clothes owned by the users, which is obtained based on a predetermined period to renew the feature information regarding the clothes owned by the users. The server 100 may change the position of the user in the multidimensional space based on the feature information renewed based on a predetermined period to reflect fashion trend on a regular basis.

The server 100 may perform a fashion coordination recommending method (i.e., S100-S400) based on the clothes owned by the user on a regular basis to continuously reflect changing user's taste. Therefore, the server 100 may recognize the change of tastes of users and user groups continuously by reflecting the changes of the users and user groups. In addition, the server 100 may recommend the recent fashion trend for coordination since the changes of tastes of the users and user groups are recognized.

Referring back to FIGS. 2 and 3, the server 100 may recommend at least one of the clothes owned by the users based on the information regarding the clothes owned by the users within the user group located in a space adjacent to the user in the multidimensional space in operation S400.

According to an embodiment, the server 100 may extract a user group located in the place adjacent to the user from among at least one user group generated in the multidimensional space, and obtain the clothing item of high preference based on the information regarding the clothes owned by the users within the extracted user group. The server 100 may suggest fashion style by coordinating the clothing item the same as or similar to the obtained clothing item of high preference with at least one clothing item among the clothes owned by the user.

The extracted user group may be the group the user group belongs to, or a user group adjacent to the user group the user belongs to.

Each user group generated in the multidimensional space may consist of users having same or similar feature information. Therefore, the users in the same user groups or in the user groups adjacent to each other is highly likely to obtain the same or similar clothing items. Therefore, the server 100 may increase the possibility of recommending the clothes that match the clothes owned by the users by using the clothes owned by other users adjacent to the user in the multidimensional space.

According to an embodiment, the server 100 may further recommend other clothes or other clothing items in addition to the clothes owned by the user. The other clothes or the other clothing items may be on-line, or off-line products having features similar to the feature information the clothes owned by the user. The recommended fashion coordination may include not only the clothes owned by the user, but also clothes the user may not own.

According to an embodiment, the fashion coordination recommending system 10 may be configured in association with a clothing retailer such as on-line or off-line shopping malls. Referring to FIG. 3, the server 100 may obtain information regarding same or similar items based on the feature information regarding the user, and select clothing items that match the clothing items owned by the user from the obtained item information to recommend the clothing items in operation S410. For example, when a particular bottom or top is selected from among the clothes owned by the user, the fashion coordination recommending system 10 may generate recommended coordination to further include the items that match the selected top and bottom and provide the recommended coordination to the user.

According to another embodiment, the server 100 may connect a user who is highly predicted to purchase items in a plurality of associated stores (on-line or off-line shopping mall) in operation S410. Specifically, the server 100 may select a recommended store and recommend the store to the user by considering whether the item having similar or same feature information regarding the user among the plurality of associated stores is in stock. For example, in response to recommending an item from an on-line shopping mall to the user to purchase, the server 100 may select the on-line shopping mall that sells items having same or similar features information regarding the user among the associated on-line shopping malls, provide the information regarding selected store to the user, and recommend the clothing item from the recommended store to the user, thereby producing an effect to attract the users to visit the shopping mall.

According to an embodiment, the server 100 may provide fashion coordination service according to time, place, and occasion (TPO).

The server 100 may perform learning of coordination patterns having high preference of users according to TPO by using artificial intelligence technology (i.e., machine learning, deep learning, etc.), and establish a learning model as a result of the learning. The server 100 may learn a coordination pattern of high preference according to TPO for each user group generated in a multidimensional space, and recommend a coordination pattern of high preference according to TPO for each user group as the result of learning.

The user terminal 200 may receive information according to the TPO from a user, and transmit the information to the server 100. Based on the learning of the coordination pattern of high preference according to TPO for each user group, the server 100 may obtain information regarding clothes having high preference according to the TPO, which is obtained from the user terminal 200, from the users in the same user group where the user belongs to or the user group adjacent to the user in the multidimensional space. The server 100 may select the clothing item of high reference according to the obtained TPO from the clothes owned by the user to recommend.

Each user group generated in the multidimensional space may consist of users having same or similar feature information. Therefore, the users in the user group where the user belongs to or the users in the user groups adjacent to each other may have same or similar taste or preference style between the users. Therefore, there is high possibility that the users have similar preference for clothing according to the TPO. The server 100 may improve the degree of satisfaction of the recommended coordination of the user by using clothing coordination according to TPO which is preferred by other users who are close to the user in the multidimensional space.

According to an embodiment, the server 100 may obtain evaluations of the clothes, fashion items, or recommended coordination, which are recommended by the user terminal 200.

According to an embodiment, the user may be provided with recommended fashion coordination to include at least one of the clothes owned by the user or items in stores from the server 100 through the user terminal 200. The user may select the clothing item among the clothes included in the recommended coordination, and the user terminal 200 may provide the information regarding the selected clothing item to the server 100.

The user may evaluate the preference or the degree of satisfaction for the recommended clothing item or fashion coordination, and the user terminal 200 may provide the evaluation result to the server 100.

The user may store information regarding the clothes recommended through the user terminal 200, or share the information with other users.

FIG. 5 is a schematic view illustrating components of a device 500 configured to recommend fashion coordination based on clothing items owned by a user according to an embodiment.

Referring to FIG. 5, a processor 510 may include a connection path to transmit and receive signals to and from at least one core (not shown) and a graphic processor (not shown) and/or other elements.

According to an embodiment, the processor 510 may execute at least one instruction stored in a memory 510. Referring to FIGS. 1 to 4, the processor 510 may perform a fashion coordination recommending method based on the clothes owned by the user.

For example, a processor 510 may perform obtaining information regarding clothes owned by a user from a user terminal by executing at least one instruction stored in a memory 520, analyzing feature information for the clothes owned by the user based on clothing factors by extracting clothing factors from the information regarding the clothes owned by the user, specifying the user in a multidimensional space indicating a degree of similarity between users based on the result of analyzing the feature information, and recommending at least one of the clothes owned by the user based on information regarding clothes of the users in a user group adjacent to the user in the multidimensional space.

The processor 510 may further include Random Access Memory (RAM), and Read-Only Memory (ROM, not shown) for storing signals (or data) processed in the processor 510. The processor 510 may be embodied in a system on chip (SoC) form including at least one of a graphic processor, RAM or ROM.

The memory 520 may store programs (at least one or more instructions) for processing and controlling the processor 510. The programs stored in the memory 520 may be distinguished by a plurality of modules according to functions.

As described above, the fashion coordination recommending method based on the clothes owned by the user according to an embodiment may be implemented with programs (or applications) to be executed in connection with a computer, which is hardware, to store in a recording medium.

The program may include codes coded as compute language such C, C++, JAVA, Python, machine language, which CPU of the computer may read through device interface of the computer, in order for the computer to read the program and execute the methods implemented as a program. Such code may include functional code related to a function defining functions necessary for executing the methods, etc., and include control codes related to execution procedure necessary for the processor of the computer to execute the functions according to a predetermined procedure. In addition, such code may further include codes related to memory reference regarding in which location of internal or outer memory of the computer additional information or media necessary for the processor of the computer to execute the functions is located (address) to be referenced. Such code may include functional codes related to a function defining functions necessary for executing the methods, etc., and include control code related to execution procedure necessary for the processor of the computer to execute the functions according to a predetermined procedure. In addition, such code may further include codes related to memory reference regarding in which location of internal or outer memory of the computer additional information or media necessary for the processor of the computer to execute the functions is located (address) to be referenced. When the processor of the computer needs to communicate with any other computer or server located remotely to execute the functions, the code may further include regarding how to communicate with any other computer or server remotely using the communication module of the computer, and which information regarding media to transmit or receive during communication.

The storage medium may not be a medium that stores data for a short period, such as a register, a cache, a memory, etc., but a medium that stores data semi-permanently to be read by a device. Specifically, examples of the storage medium may include ROM, RAM, CD-ROM, magnetic tape, floppy disk, and optical data storage device, but are not limited to. That is, the program may be stored in various recording media on various servers accessible by the computer or in various recording media on the computer of the user. In addition, the medium may be distributed in a computer system connected by network, wherein a computer readable code may be stored in a distributed manner.

The operations of a method or algorithm described in relation to an embodiment of the present disclosure may be implemented directly in hardware, as a software module executed by hardware, or by a combination thereof. A software module may include random access memory (RAM), read only memory (ROM), erasable programmable ROM (EPROM), electrically erasable programmable ROM (EEPROM), flash memory, hard disk, removable disk, CD-ROM, or in any type of computer-readable recording medium well known in the art to which the present disclosure pertains.

As described above, the embodiments of the present disclosure have been described with reference to the accompanying drawings, but those skilled in the art to which the present disclosure pertains know that the present disclosure may be embodied in other specific forms without changing its technical spirit or essential features. Therefore, it would be understood that the embodiments described above are illustrative in all respects, and not limited thereto.

1. A method for recommending fashion coordination based on clothes owned by a user, the method comprising:
obtaining information regarding clothes owned by a user from a user terminal;
obtaining social data connected to the user;
calculating feature information indicating a preference for clothes or coordination patterns of the user based on the information regarding the clothes owned by the user and the social data connected to the user;
specifying the user in a multidimensional space indicating a degree of similarity between users based on the feature information regarding the user; and
providing recommended coordination including at least one clothing item to the user based on feature information regarding at least one user adjacent to the user or a user group in the multidimensional space.

2. The method as claimed in claim 1, wherein the specifying of the user comprises:
obtaining coordinate information corresponding to the feature information regarding the user; and mapping the user to the obtained coordinate information in the multidimensional space.

3. The method as claimed in claim 1, wherein the recommended coordination includes at least one clothing item among the clothes owned by the user or other clothes, and wherein other clothes include at least one or more clothing items for sale which have a feature relating to the feature information regarding the user.

4. The method as claimed in claim 1, further comprising:
providing recommended store information to the user, wherein the recommended store includes selecting whether a clothing item having features the same as or similar to the feature information regarding the user is sold among the plurality of stores associated with the server.

5. The method as claimed in claim 1, wherein the providing of the recommended coordination comprises:
obtaining information according to time, place, and occasion (TPO) from the user terminal; and
providing a TPO recommended coordination of highly preferred coordination pattern according to the TPO of at least one user adjacent to the user or a user group in the multidimensional space in consideration of the TPO.

6. The method as claimed in claim 1, further comprising:
obtaining evaluation for the recommended coordination from the user terminal.

7. The method as claimed in claim 6, wherein the obtaining of the evaluation comprises receiving selected clothing item or coordination selected to be worn by the user among clothing items included in the recommended coordination.

8. The method as claimed in claim 7, further comprising:
updating feature information or preferred coordination patterns of the user or the user group by reflecting preference or degree of satisfaction for the recommended coordination, the selected clothing item, or coordination, or social data associated with the user based on a predetermined period.

9. A fashion coordination recommending device based on clothes owned by a user, the device comprising:
a memory configured to store at least one instruction, and
a processor configured to execute the at least one instruction stored in the memory,
wherein the processor is configured to:
in response to executing the at least one or more instructions,
obtain information regarding clothes owned by a user from a user terminal,
calculate feature information indicating preference for the clothes of the user based on the information regarding the clothes owned by the user and social data associated with the user,
specify the user in a multidimensional space indicating a degree of similarity between users based on the feature information regarding the user, and
provide recommended coordination including at least one clothing item to the user based on feature information regarding at least one user adjacent to the user of a user group in the multidimensional space.

10. The device as claimed in claim 9, wherein the processor is configured to,
in response to specifying the user, obtain coordinate information corresponding to the features information regarding the user in the multidimensional space and map the user to the obtained coordinate information.

11. The device as claimed in claim 9, wherein the recommended coordination comprises, at least one clothing item among the clothes owned by the user or other clothes, and
wherein the other clothes include at least one clothing item for sale having similar feature information to the user.

12. The device as claimed in claim 9, wherein the processor is configured to provide recommended store information to the user, and
wherein the recommended store is selected by considering whether a clothing item the same as or similar to the feature information regarding the user is sold among a plurality of stores associated with the server.

13. The device as claimed in claim 9, wherein the processor is configured to,
in response to providing the recommended coordination, and obtaining information according to time, place and occasion (TPO) from the user terminal,
provide TPO recommended coordination of high reference according to the TPO of at least on user adjacent to the user or a user group in the multidimensional space by further considering the obtained TPO.

14. The device as claimed in claim 9, wherein the processor is configured to obtain evaluation for the recommended coordination from the user terminal.

15. The device as claimed in claim 14, wherein the processor is configured to,
in response to obtain the evaluation, receive selected clothing item or coordination selected to be worn by the user among the clothes included in the recommended coordination.

16. The device as claimed in claim 15, wherein the processor is configured to update feature information or preferred coordination patterns of the user or a user group by reflecting preference of a degree of satisfaction of the user for the recommended coordination, the selected clothing item or coordination, or social data associated with the user.

17. A non-volatile computer readable recording medium, wherein a fashion coordination recommending program based on clothes owned by a user is recorded for controlling a computer to perform the method of claim 1.
